(19) United States
(12) Patent Application Publication
(10) Pub. No.: US 2016/0125880 A1
(43) Pub. Date: May 5, 2016

(54) METHOD AND SYSTEM FOR IDENTIFYING LOCATION ASSOCIATED WITH VOICE COMMAND TO CONTROL HOME APPLIANCE

(71) Applicants: Zhigang ZHANG, Haidian District, Beijing (CN); Yanfeng ZHANG, Haidian District, Beijing (CN); Jun XU, Haidian District, Beijing (CN)

(72) Inventors: Zhigang ZHANG, Beijing (CN); Yanfeng ZHANG, Beijing (CN); Jun XU, Beijing (CN)

(21) Appl. No.: 14/894,518

(22) PCT Filed: May 28, 2013
(86) PCT No.: PCT/CN2013/076345

§ 371 Date: Nov. 28, 2015

(51) Int. Cl. G10L 15/22; G10L 25/06; G06F 3/16; G10L 25/24

(52) U.S. Cl. CPC G10L 15/22; G10L 25/24; G10L 25/06; G06F 3/167; G10L 2015/228

(57) ABSTRACT

The present invention relates to a method for controlling a home appliance located in assigned room with voice commands in home environment. The method comprises the steps of: receiving a voice command by a user; recording the received voice command; sampling the recorded voice command and feature extracting from the recorded voice command; determining room label by comparing the extracted features of the voice command with feature references, wherein the room label is associated with the feature references; assigning the room label to the voice command; and controlling the home appliance located in the assigned room in accordance with the voice command.

### FIELD OF THE INVENTION

The present invention relates to a method and system for identifying the location associated with voice command in a home environment to control a home appliance. More particularly, the present invention relates to a method and system for identifying where the voice command by a user is emitted with machine learning method and then performing the action of the voice command on the home appliance in the same room as the user.

### BACKGROUND OF THE INVENTION

Personal assistant applications by voice command on mobile phone are becoming popular now. Such kind of applications use natural language processing to answer questions, make recommendations, and perform actions on home appliances such as TV sets by delegating requests to the destination TV set or STB (Set-Top-Box).

However, in a typical home environment where there are more than one TV set, it is ambiguously to decide which TV set should be turned on without the appropriate location information related with where the voice command is said if the application just identifies that a user says “turn on TV” to the mobile phone. So an additional method is necessary to determine which TV set is to be controlled based on the context of the user command.

The solution proposed in this application solves the problem that current state-of-the art personal assistant application by voice command can't correctly identify which TV set needs to be controlled if there are multiple TV sets at home environment.

By proposing a method to extract features with the recorded “turn on TV” voice command and identify where the voice command of “turn on TV” is said by analyzing the features with classification methods, the method can find the location associated with the voice command and then turn on the television in the same room.

The home appliances include multiple TV sets, air-conditioning equipments, illumination equipments, and so on.

As related art, U.S. 20100332668A1 discloses a method and system for detecting proximity between electronic devices.

### SUMMARY OF THE INVENTION

According to an aspect of the present invention, there is provided a method for controlling a home appliance located in assigned room with voice commands in home environment, the method comprising the steps of: receiving a voice command by a user; recording the received voice command; sampling the recorded voice command and feature extracting from the recorded voice command; determining room label by comparing the extracted features of the voice command with feature references, wherein the room label is associated with the feature references; assigning the room label to the voice command; and controlling the home appliance located in the assigned room in accordance with the voice command.

According to another aspect of the present invention, there is provided a system for A system for controlling a home appliance located in assigned room with voice commands in home environment, the system comprising: a receiver for receiving a voice command by a user; a recorder for recording the received voice command; and a controller configured to: sample the recorded voice command and feature extracting from the recorded voice command; determine room label by comparing the extracted features of the voice command with feature references, wherein the room label is associated with the feature references; assign the room label to the voice command; and control the home appliance located in the assigned room in accordance with the voice command.

### BRIEF DESCRIPTION OF DRAWINGS

These and other aspects, features and advantages of the present invention will become apparent from the following description in connection with the accompanying drawings in which:

FIG. 1 shows an exemplary circumstance where there are more than one TV set in different rooms in a home environment according to an embodiment of the present invention;

FIG. 2 shows an exemplary flow chart illustrating a classification method according to an embodiment of the present invention; and

FIG. 3 shows an exemplary block diagram illustrating a system according to an embodiment of the present invention.

### DETAILED DESCRIPTION

In the following description, various aspects of an embodiment of the present invention will be described. For the purpose of explanation, specific configurations and details are set forth in order to provide a thorough understanding. However, it will also be apparent to one skilled in the art that the present invention may be implemented without the specific details present herein.

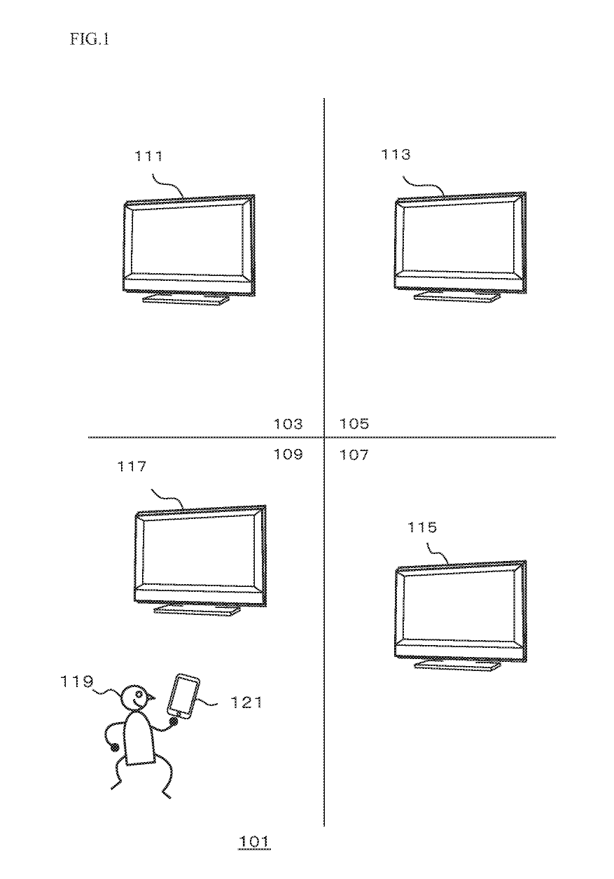

FIG. 1 shows the circumstance there are more than one TV set 111, 113, 115, 117 in different rooms 103, 105, 107, 109 in a home environment 101. Under the home environment 101, it is impossible for a voice command system based personal assistant application on mobile phone to determine which TV set is needed to be controlled if a user 119 just instructs “turn on TV” to the mobile phone 121.

In order to address the issue, this invention takes into account the surrounding acoustics when the user instructs the voice command of “turn on TV” and leverage the existing correlations among the voice command and its surrounding such as voice features and command time into the voice command understanding, in order to identify where the voice command is instructed with machine learning method and then turn on the television in the same room.

In the invention, the personal assistant application includes a voice classification system which combines three processing stages: 1. voice recording, 2. feature extraction and 3. classification. A variety of signal features including low-level parameters such as the zero-crossing rate, signal bandwidth, spectral centroid, and signal energy have been used. Another set of features used, inherited from automatic speech recognizers, is the set mel-frequency cepstral coefficients (MFCC). It means the voice classification module will combine standard features with representations of rhythm and pitch content.
1. Voice recording

Every time when a user instructs the voice command of “turn on TV”, the personal assistant application records the voice command and then provides the feature analysis module with the recorded audio for further processing.
2. Feature analysis

In order to get high accuracy for location classification, a system according to the invention samples the recorded audio into 8 KHz sample rate and then segment it into segments by one-second window, for example. Then this one-second audio segment is taken as the basic classification unit in its algorithms, and is further divided into forty 25 ms non-overlapping frames. Each feature is extracted based on these forty frames in one-second audio segment. Then the system selects good features that can identify the effect on the recorded audio posed by the different environment in different rooms.

Several basic features to be extracted and analyzed include: audio mean, which measures mean of the audio segment vector; audio spread, which measures the spread of recorded audio segment spectrum; zero-crossing rate ratio, which counts the number of sign changes of the audio segment waveform; short-time energy ratio, which describes the short time energy of the audio segment by computing using root mean square. Furthermore, it is proposed to also select two more advanced features for the recorded voice command, MFCC and a reverberation effect coefficient.

MFCC (Mel-Frequency Cepstral Coefficients) represents the shape of the spectrum with very few coefficients. The cepstrum is defined as the Fourier transform of the logarithm of the spectrum. The Melcepstrum is the spectrum computed on the Mel-bands instead of the Fourier spectrum. MFCC can be computed according to the following steps:
1. Take the Fourier transform on the audio signal;
2. Map the powers of the spectrum obtained above onto the mel scale;
3. Take the logs of the powers at each of the mel frequencies;
4. Take the discrete cosine transform of the list of mel log powers;
5. Take the amplitudes of the resulting spectrum as MFCC.

Meanwhile, different rooms pose different reverberation effects on the recorded voice command. Depending on how far each new syllable is submerged into the reverberant noise in different rooms, which have different size and environment settings, the recorded audio have varying auditory perception. It is proposed to extract reverberation features from the audio recordings according to the following steps:
1. Perform a short time Fourier transform to transform the audio signal into a 2D time-frequency representation in which reverberation features appear as blurring of spectral features in the time dimension;
2. Quantitatively estimate the amount of reverberation by transforming the image of representing the 2D time-frequency property to a wavelet domain where efficient edge detection and characterization can be performed;
3. The resulting quantitative estimates of reverberation time extracted in this way are strongly correlated with physical measurements, and is taken as the reverberation effect coefficient.

Further, other non-voice features associated with the recording voice command can also be considered. It includes, for example, the time when the voice command is recorded, as the pattern that a user tends to watch TV in a specific room at the same time in different days exists.
3. Classification

With the features extracted in the above step, it is proposed to identify in which room the audio clip is recorded using a multi-class classifier. It means when a user talks to the mobile phone with the voice command of “turn on TV”, the personal assistant software on the mobile phone can successfully identify in which room, for example, room 1, room 2 or room 3, the voice command is given by analyzing the features related with the recorded audio, and then turn on the TV in the associated room.

It is proposed to use k-nearest neighbor scheme as the learning algorithm in the invention. Formally, the system need to predict an output variable Y, given a set of input features, X. In our setting, Y would be 1 if the recording voice command is associated with room 1, 2 if the recording voice command is associated with room 2,and etc, while X would be a vector of feature values extracted from the recording voice command.

The training samples for references are voice feature vectors in a multidimensional feature space, each with a class label of room 1, room 2 and room 3. The training phase of the process consists only of storing the feature vectors and class labels of the training samples for references. The training samples are used as references to classify coming voice commands. The training phase may be set as a predetermined period. Or else, references can be accumulated after training phase. In reference table, features are related with the room labels.

In the classification phase, a recording voice command is classified by assigning the room label which is the most frequent among the k-nearest training references to the features of the recorded voice command. So, the room in which the audio stream is recorded can be got from the classification results. Then the television in the corresponding room can be turned on by an embedded infrared communication equipment with the mobile phone.

Furthermore, other classification strategies, including decision tree and probabilistic graphical model, can also be employed in the idea disclosed in this invention.

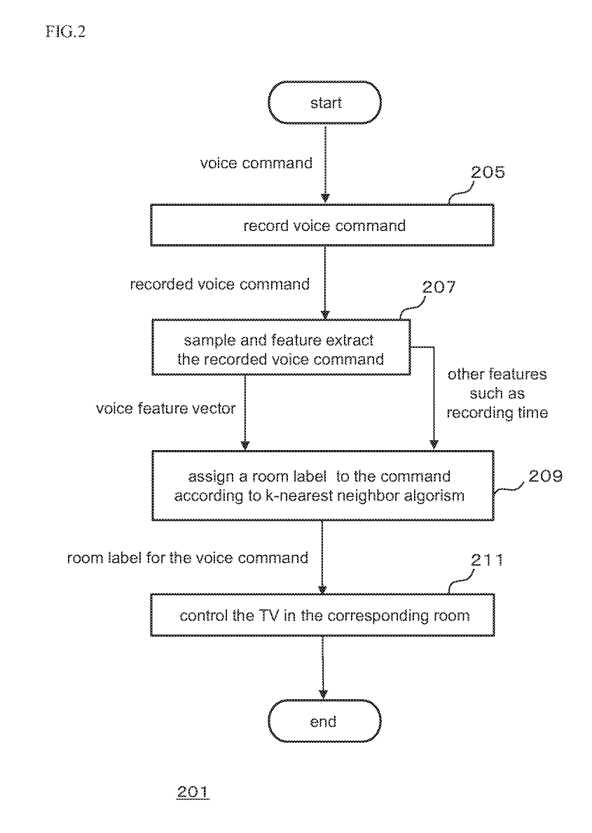

A diagram illustrating the whole voice command recording, feature extraction and classification process is shown in the FIG. 2.

FIG. 2 shows an exemplary flow chart 201 illustrating a classification method according to an embodiment of the invention.

First, a user instructs a voice command such as “turn on TV” on a mobile device such as a mobile phone.

At step 205, the system records the voice command.

At step 207, the system samples and feature extracts the recorded voice command.

At step 209, the system assigns room label to the voice command according to L-nearest neighbor class algorism on the basis of the voice feature vector and the other features such as recording time. The reference table including features and related room labels are used for this procedure.

At step 211, the system controls the TV in the corresponding room to the room label for the voice command.

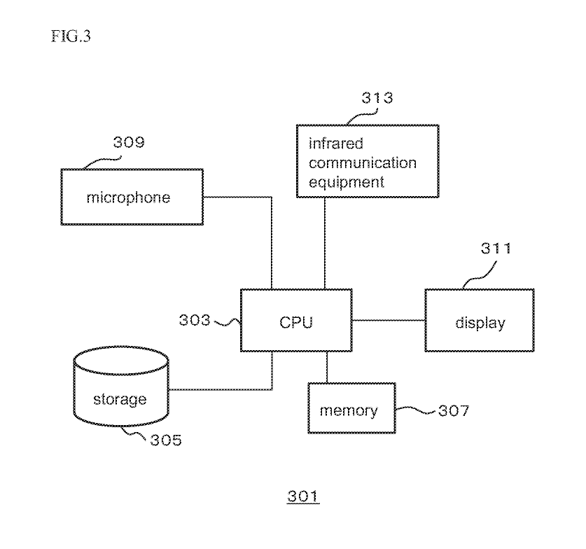

FIG. 3 illustrates an exemplary block diagram of a system 301 according to an embodiment of the present invention. The system 301 can be a mobile phone, computer system, tablet, portable game, smart-phone, and the like. The system 301 comprises a CPU (Central Processing Unit) 303, a micro phone 309, a storage 305, a display 311, and a infrared communication equipment 313. A memory 307 such as RAM (Random Access Memory) may be connected to the CPU 303 as shown in FIG. 3.

The storage 305 is configured to store software programs and data for the CPU 303 to drive and operate the processes as explained above.

The micro phone 309 is configures to detect a user's command voice.

The display 311 is configured to visually present text, image, video and any other contents to a user of the system 301.

The infrared communication equipment 313 is configured to send commands to any home appliances on the basis of the room label for the voice command. Other communication equipment can be replaced the infrared communication equipment. Alternatively, the communication equipment can send command to a central system controlling all of home appliances.

The system can instruct any home appliances such as TV sets, air-conditioning equipments, illumination equipments, and so on.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1-8. (canceled)

9. A method for controlling an appliance located in a corresponding environment to a voice command, the method comprising the steps of:
recording a received voice command by a user;
sampling the recorded voice command and features extracted from the recorded voice command, the features including voice related features and non-voice related features; and
controlling the appliance located in the corresponding environment to assigned environment label which is associated with feature references, wherein the environment label is assigned to the voice command by comparing the features extracted from the voice command with the feature references, the feature references are accumulated by the sampling.

10. The method according to claim 9, wherein the feature references are accumulated by the sampling including training phase.

11. The method according to claim 9, the step of determining environment label is performed on the basis of K-nearest neighbor algorism.

12. The method according to claim 9, wherein the voice features are MFCC (Mel-Frequency Cepstral Coefficients) and reverberation effect coefficient, and non-voice feature is the time when the voice command is recorded.

13. A system for controlling an appliance located in a corresponding environment to a voice command, the system comprising:
a recorder for recording a received voice command by a user; and
a controller configured to:
sample the recorded voice command and features extracted from the recorded voice command, the features including voice related features and non-voice related features; and
control the appliance located in the corresponding environment to assigned environment label which is associated with feature references, wherein the environment label is assigned to the voice command by comparing the features extracted from the voice command with the feature references, the feature references are accumulated by the sampling.

14. The method according to claim 13, wherein the feature references are accumulated by the sampling including training phase.

15. The system according to claim 13, wherein the controller determine environment label on the basis of K-nearest neighbor algorism.

16. The system according to claim 13, wherein the voice features are MFCC (Mel-Frequency Cepstral Coefficients) and reverberation effect coefficient, and non-voice feature is the time when the voice command is recorded.
